(19) United States
(12) Patent Application Publication
(10) Pub. No.: US 2022/0383092 A1
(43) Pub. Date: Dec. 1, 2022

(54) TURBO TRAINING FOR DEEP NEURAL NETWORKS

(71) Applicant: Microsoft Technology Licensing, LLC, Redmond, WA (US)

(72) Inventors: Ritchie ZHAO, Bellevue, WA (US); Bita DARVISH ROUHANI, Bellevue, WA (US); Eric S. CHUNG, Woodinville, WA (US); Douglas C. BURGER, Bellevue, WA (US); Maximilian GOLUB, Seattle, WA (US)

(21) Appl. No.: 17/330,395

(22) Filed: May 25, 2021

(51) Int. Cl. G06N 3/08; G06N 3/063

(52) U.S. Cl. CPC G06N 3/08; G06N 3/063

(57) ABSTRACT

Embodiments of the present disclosure includes systems and methods for reducing computational cost associated with training a neural network model. A neural network model is received and a neural network training process is executed in which the neural network model is trained according to a first fidelity during a first training phase. As a result of a determination that training of the neural network model during the first training phase satisfies one or more criteria, the neural network model is trained at a second fidelity during a second training phase, the second fidelity being a higher fidelity than the first fidelity.

### BACKGROUND

The present disclosure relates to a computing system. More particularly, the present disclosure relates to techniques for training an artificial neural network.

The present disclosure relates to a computing system. More particularly, the present disclosure relates to techniques for training an artificial neural network. Artificial intelligence (AI) systems have allowed major advances in a variety of fields such as natural language processing and computer vision. AI systems typically include an AI model (e.g., a neural network model) comprised of multiple layers. Each layer typically includes nodes (e.g., neurons) that are connected to nodes in other layers. Connections between nodes are associated with trainable weights for increasing or decreasing strengths of the connections. Bias may be associated with the input for each node to adjust an activation function for a layer in a neural network. In operation, a data set is applied to an input layer of the model and outputs are generated at an output layer. The outputs may correspond to classification, recognition, or prediction of a particular feature of the input data set. To train the neural network, the outputs are compared against known outputs for the input data set and an error may be backpropagated through the model and the parameters of the model may be adjusted in response.

Some neural networks may have many parameters or may have a large structure with many nodes, layers, and/or connections. A significant amount of computational resources and/or time may be necessary to appropriately train such neural networks.

### BRIEF DESCRIPTION OF THE DRAWINGS

FIG. 1 illustrates a system for training an artificial neural network according to one or more embodiments.

FIG. 2 illustrates a method of training an artificial neural network according to one or more embodiments.

FIG. 3 illustrates an environment in which an artificial neural network is trained using fidelity attributes according to one or more embodiments.

FIG. 4 illustrates fidelity attributes and hyperparameters that are implemented to train an artificial neural network according to one or more embodiments.

FIG. 5 illustrates fidelity attributes and hyperparameters used to train an artificial neural network model during a first training phase and a second training phase according to one or more embodiments.

FIG. 6 illustrates an example of adjustments to sparsity aspects associated with various portions of an artificial neural network according to one or more embodiments.

FIG. 7 illustrates an example of partial model training that may be implemented during the first training phase and the second training phase.

FIG. 8 illustrates a graph of a first learning rate during training of a first artificial neural network according to one or more embodiments relative to a second learning rate during training of a second artificial neural network.

FIG. 9 illustrates a method of training an artificial neural network according to one or more embodiments.

FIG. 10 illustrates a first graph of training loss during training of a first artificial neural network according to one or more embodiments relative to a second graph of training loss during training of a second artificial neural network.

FIG. 11 illustrates a simplified block diagram of an example computer system according to one or more embodiments.

FIG. 12 illustrates a illustrates an artificial neural network processing system according to one or more embodiments.

### DETAILED DESCRIPTION

In the following description, for purposes of explanation, numerous examples and specific details are set forth in order to provide a thorough understanding of the present disclosure. Such examples and details are not to be construed as unduly limiting the elements of the claims or the claimed subject matter as a whole. It will be evident to one skilled in the art, based on the language of the different claims, that the claimed subject matter may include some or all of the features in these examples, alone or in combination, and may further include modifications and equivalents of the features and techniques described herein.

For deep learning, artificial intelligence (AI) models (e.g., neural network models) typically increase in the accuracy of their predictions with increase in size (e.g., the number of layers, nodes, connections, and/or the like). This is often measured during training as a desirable decrease in validation loss (e.g., more accurate in predictions).

However, increases in model size typically require increases in computational resources and/or time to process the model. This is due to the growing number of parameters associated with increases in model size which, in turn, require further calculation.

For example, for each node of a neural network (NN) model, a forward pass calculation represented by y=f (x₀w₀+x₁w₁+ . . . +xₙwₙ) may be executed, where y represents an output value of the node, x represents input values from connected nodes 0 to n, and w represents trainable weights (e.g., parameters) associated with connections from nodes. During training, outputs of the model (e.g., at the last layer) may be compared against known outputs for an input data set. Then, a similar backward pass calculation (e.g., backpropagation) may be executed to determine gradients and weight updates. For example, in a process known as stochastic gradient descent (SGD), backpropagation may be done multiple times (e.g., iteratively) for subsets of the training data set. Calculations in the forward and backward passes are typically performed by matrix multiplication (e.g., Mat-Mul) operations executed numerous times for each layer of a model. As a result, the number of calculations required for training a model may grow quickly with increases in model size.

Various adjustments to training may be implemented to reduce computational resources and/or the time to process a neural network model. For example, an AI processor may train a neural network model using a lower precision level (e.g., 8-bit integer) than a highest precision level of the AI processor (e.g., 32-bit floating point). As another example, the complexity of the neural network model may be adjusted to reduce the training time.

However, reducing precision or complexity may also reduce the accuracy of the trained neural network. Moreover, under these reduced conditions, models sometimes worsen in the accuracy of their predictions with continued training (e.g., divergence) rather than improve.

Features and advantages of the present disclosure include improving training of neural network models by training a neural network under different levels of fidelity. During a first training phase, the neural network may be trained at a low fidelity until one or more criteria are satisfied. Then, during a second training phase, the neural network is trained at a higher fidelity. Techniques disclosed herein may support improved training performance that may reduce the overall computational resources and/or time to train a neural network to a level of performance at least equal to or comparable with the performance of a neural network trained entirely at a higher fidelity. Advantageously, this may allow lower validation losses (e.g., improved accuracy in predictions) toward convergence while providing a reduction of computational resources and/or time to process (e.g., reduction of compute cycles) for very large models. One or more embodiments may involve techniques for automatically adjusting training parameters during training to achieve higher performance by the trained neural network.

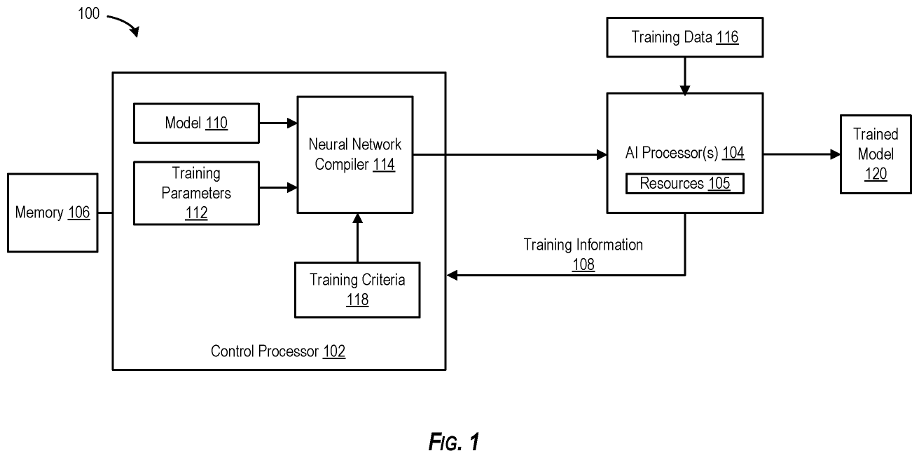

FIG. 1 illustrates a system for training an artificial neural network according to one or more embodiments. In this example, one or more control processor(s) 102 may be in communication with one or more AI processor(s) 104. Control processor(s) 102 may include traditional CPUs, FPGAs, systems on a chip (SoC), application specific integrated circuits (ASICs), or embedded ARM controllers, for example, or other processors that can execute software and communicate with AI processor(s) 104 based on instructions in the software. AI processor(s) 104 may include graphics processors (GPUs), AI accelerators, or other digital processors optimized for AI operations (e.g., matrix multiplications versus Von Neuman Architecture processors such as the x86 processor). Example AI processor(s) may include GPUs (e.g., NVidia Volta® with 800 cores and 64 MultiAccumulators) or a Tensor Processor Unit (TPU) (e.g., 4 cores with 16k operations in parallel), for example.

In this example, a control processor 102 may be coupled to memory 106 (e.g., one or more non-transitory computer readable storage media) having stored thereon program code executable by control processor 102. The control processor 102 receives (e.g., loads) a neural network model 110 (hereinafter, “model”) and a plurality of training parameters 112 for training the model 110. The model 110 may comprise, for example, a graph defining multiple layers of a neural network with nodes in the layers connected to nodes in other layers and with connections between nodes being associated with trainable weights. The training parameters 112 (e.g., tuning parameters, model parameters, fidelity attributes) may comprise one or more values which may be adjusted to affect configuration and/or execution of the model 110. The training parameters 112 that may be used in various embodiments include model size, batch size, learning rate, precision (e.g., number of bits in a binary representation of data values, type of numerical data), and sparsity (e.g., number of zero values relative to non-zero values in matrices), normalization (e.g., weight decay, activation decay, L2 normalization), entropy, and/or training steps, by way of non-limiting example. Other parameters or attributes may be included in the training parameters 112 that may be characterized and adjusted as would be apparent to those skilled in the art in light of the present disclosure. In some embodiments, the training parameters 112 may include one or more hyperparameters (e.g., parameters used to control learning of the neural network) as known to those skilled in the art.

The control processor 102 may also execute a neural network compiler 114. The neural network compiler 114 may comprise a program that, when executed, may receive model 110 and training parameters 112 and configure resources 105 on one or more AI processors 104 to implement and execute model 110 in hardware. For instance, the neural network compiler 114 may receive and configure the model 110 based on one or more of the training parameters 112 to execute a training process executed on AI processor(s) 104. The neural network compiler 114 may cause the one or more AI processors 104 to implement calculations of input activations, weights, biases, backpropagation, etc., to perform the training process. The AI processor(s) 104, in turn, may use resources 105, as determined by the neural network compiler 114, to receive and process training data 116 with model 110 (e.g., the training process). The resources 105 may include, for example, registers, multipliers, adders, buffers, and other digital blocks used to perform operations to implement model 110. The AI processor(s) 104 may perform numerous matrix multiplication calculations in a forward pass, compare outputs against known outputs for subsets of training data 116, and perform further matrix multiplication calculations in a backward pass to determine updates to various neural network training parameters, such as gradients, biases, and weights. This process may continue through multiple iterations as the training data 116 is processed. In some embodiments, AI processor(s) 104 may determine the weight updates according to a backpropagation algorithm that may be configured by the neural network compiler 114. Such backpropagation algorithms include stochastic gradient descent (SGD), Adaptive Moment Estimation (ADAM), and other algorithms known to those skilled in the art.

During training of the model 110, one or more values for activations, biases, weights, gradients, or other parameter may be generated or updated for one or more layers, nodes, and/or connections of the model 110. During training, the AI processor(s) 104 may generate training information 108 that is useable to determine a status or a progress of training the model 110. The AI processor(s) 104 may provide the training information 108 to the control processor(s) 102. The AI processor(s) 104 and/or the control processor 102 may use the training information 108 to determine whether to adjust various parameters or attributes of the neural network training process. The control processor 102 may obtain or possess training criteria 118 for determining whether to adjust the training attributes or parameters.

According to one or more embodiments of the present disclosure, the fidelity of training of the model 110 may be adjusted during the neural network training process. The term fidelity as used herein refers to the quality of training the model 110 receives for a given phase of training. Adjustments in the fidelity of the neural network training process may be implemented by adjusting various attributes. Fidelity attributes that can be adjusted according to one or more embodiments include precision of the training process and/or sparsity of the training process. In some embodiments, full or partial model training may be implemented to adjust the fidelity of the training process. According to one or more embodiments, the training process includes training the model 110 at a first fidelity for a first training phase and training the model 110 at a second fidelity for a second training phase, wherein the first fidelity is a lower fidelity level than the second fidelity. Moreover, training at the first fidelity is less intensive in terms of computational resources utilized than training at the second fidelity.

In some embodiments, one or more hyperparameters (e.g., in the training parameters 112) for a training phase for training the model 110 may be determined and set based, for example, on a fidelity for the training phase. Further, one or more hyperparameters may be adjusted during a training phase based on the fidelity or on other factors, such as the training information 108. By way of non-limiting example, the control processor 102 may establish parameters for training the model 110 at a first fidelity for a first training phase. While the model 110 is being trained in the first training phase, a first hyperparameter may be decreased over the course of the first training phase.

In some embodiments, the training parameters 112 may be provided to the neural network compiler 114 for updating the implementation of the model 110 on AI processor(s) 104, the updated model 110 to be subsequently executed by the AI processor(s). As a result, the model 110 trained in a first training phase may have different characteristics (e.g., sparsity) than the model 110 trained in a second training phase. The neural network training process may include multiple iterations until one or more criteria are satisfied—for example, until the model 110 converges to within a defined threshold. Ultimately, a trained model 120 is produced that is configured to operate for a particular application or purpose. Advantageously, by training the model 110 at different levels of fidelity, fewer computational resources are utilized to achieve the trained model 120 relative to a neural network model trained at a high fidelity utilizing a consistently large amount of computational resources. Advantageously, by training the model 110 at a plurality of successively increasing fidelities, fewer computational resources are utilized to achieve the trained model 120 relative to a neural network model trained at a high fidelity utilizing a consistently large amount of computational resources. Moreover, the amount of time taken to train the trained model 120 is the same as or less than the amount of time taken to train a neural network model at high fidelity, and training loss performance of the trained model 120 is not sacrificed in the process.

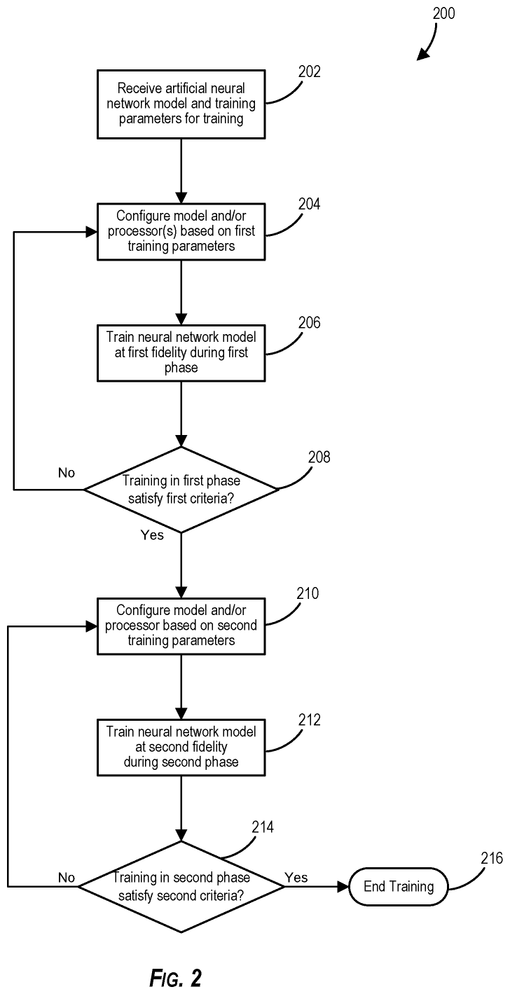

FIG. 2 shows a method 200 for training a neural network model at two different fidelities according to one or more embodiments. The method 200 may be performed by one or more processing entities described herein, such as the control processor(s) 102 and/or the AI processor(s) 104. At 202, one or more processors receive a neural network model (e.g., the model 110) and may receive parameters for training the model. The training parameters include first training parameters indicating parameters, fidelity attributes, hyperparameters, and/or criteria for training the model in a first training phase. The training parameters may also include second training parameters indicating parameters, fidelity attributes, hyperparameters, and/or criteria for training the model in a second training phase, as described herein.

At 204, the neural network model and/or one or more processors are configured based on the first training parameters received in 202. The first training parameters include information corresponding to a first fidelity at which the model 110 is to be trained during a first training phase. The first training parameters may include information indicating a precision and/or a sparsity for training the model 110 during the first training phase. The first training parameters may include information regarding a partial model training to be implemented to train the model 110 during the first phase. In general, the first training parameters cause the model 110 to be trained at a first fidelity that is lower relative to a second fidelity to be implemented during a second training phase. This may include, by way of non-limiting example, adjusting the model 110 to have a higher sparsity, configuring the AI processor(s) 104 to operate at a lower precision, or configuring the AI processor(s) 104 to train only a first part of the model 110. At 204, various hyperparameters (e.g., learning rate, batch size) may be adjusted based on the first training parameters.

At 206, the control processor(s) 102 cause the AI processor(s) 104 to train the neural network model 110 at the first fidelity based on the first training parameters. Training 206 at the first fidelity may involve operations by the AI processor(s) 104 that include providing the training data 116 to the model 110, receiving output from one or more layers or one or more nodes of the model 110, and adjusting various parameters (e.g., weights, activations, biases) associated with the model 110 based on the output received. As described herein, the AI processor(s) 104 may operate at a lower precision than the AI processor(s) 104 can perform—for instance, operating at a lower precision level (e.g., 8-bit) or operating using a lower precision data type (e.g., integer) than would be implemented during in a high precision mode.

The control processor(s) 102 and/or the AI processor(s) 104 determine, at 208, whether training during the first training phase satisfies one or more first criteria. The one or more first criteria may include a criterion related to convergence, such as a criterion specifying a threshold for training loss convergence. More specifically, the criterion may specify that performance of the model 110 has converged if the training loss remains within a defined threshold (e.g., ±1%) of a training loss value or error for a defined number of samples. Training loss, as referred to herein, refers to a measure of model output relative to known correct output for a given set of training data. The training loss may be represented as an error calculated based on a statistical function (e.g., mean-square error). In some embodiments, the one or more first criteria may specify a temporal criterion, such as an amount of time, or a numerical criterion, such as a number of iterations, for which the first training phase is performed.

As a result of determining in 208 that the one or more first criteria are not satisfied, the method 200 proceeds back to 204, where the model or the processors may be further configured based on the training parameters. For instance, the learning rate for the training, the precision, the sparsity, or hyperparameters may be adjusted before the model 110 is subjected to further training in the first training phase. On the other hand, if it is determined in 208 that one or more of the first criteria are satisfied, the method 200 proceeds to 210.

At 210, the neural network model and/or one or more processors are configured based on second training parameters received. The second training parameters may have been received in 202 or the second training parameters may be received in connection with satisfaction of the one or more first criteria described with respect to 208. The second training parameters include information corresponding to a second fidelity at which the model 110 is to be trained during a second training phase. The second training parameters may include information indicating a precision and/or a sparsity for training the model 110 during the second training phase. The second training parameters may include information specifying that more of the model 110 is to be trained during the second phase. In some embodiments, the second training parameters may, for example, indicate that a larger portion of the model 110 (e.g., a greater number of nodes, a greater number of layers) are to be trained during the second training phase than the first training phase; however, the larger portion is not necessarily the entire model 110. In some embodiments, the second training parameters may indicate that the entire model 110 (e.g., all nodes, all layers) are to be trained during the second training phase.

In general, the second training parameters cause the model 110 to be trained at a second fidelity that is higher relative to the first fidelity implemented during the first training phase. This may include, by way of non-limiting example, adjusting the model 110 to have a lower sparsity, configuring the AI processor(s) 104 to operate at a higher precision, or configuring the AI processor(s) 104 to train the entire model 110 during the second training phase. At 210, various hyperparameters (e.g., learning rate, batch size) may be adjusted based on the second training parameters.

At 212, the control processor(s) 102 cause the AI processor(s) 104 to train the neural network model 110 at the second fidelity based on the second training parameters. Training 212 at the second fidelity may involve operations by the AI processor(s) 104 that include providing the training data 116 to the model 110, receiving output from one or more layers or one or more nodes of the model 110, and adjusting various parameters (e.g., weights, activations, biases) associated with the model 110 based on the output received. As described herein, the AI processor(s) 104 may operate at a higher precision than the AI processor(s) operated in 206—for instance, operating at a high precision level (e.g., 32-bit) or operating using a high precision data type (e.g., floating point, double floating point).

At 214, The control processor(s) 102 and/or the AI processor(s) 104 determine 208 whether training during the second training phase satisfies one or more second criteria. The one or more second criteria may include a criterion related to convergence, such as a criterion specifying a threshold for training loss convergence. More specifically, the criterion may specify that performance of the model 110 has converged if the training loss remains within a defined threshold (e.g., ±1%) of a target training loss. The target training loss may correspond, in some embodiments, to the training loss of a neural network model trained under high fidelity conditions (e.g., full precision and no sparsity). In some embodiments, the one or more second criteria may specify a temporal criterion, such as an amount of time, or a numerical criterion, such as a number of iterations, for which the second training phase is performed.

As a result of determining in 214 that the one or more second criteria are not satisfied, the method 200 proceeds back to 210, where the model or the processors may be further configured based on the training parameters. For instance, the learning rate for the training, the precision, the sparsity, or hyperparameters may be adjusted before the model 110 is subjected to further training in the second training phase. On the other hand, if it is determined in 214 that one or more of the second criteria are satisfied, the method 200 proceeds to 216, where the neural network training procedure ends and the trained neural network model 120 is produced.

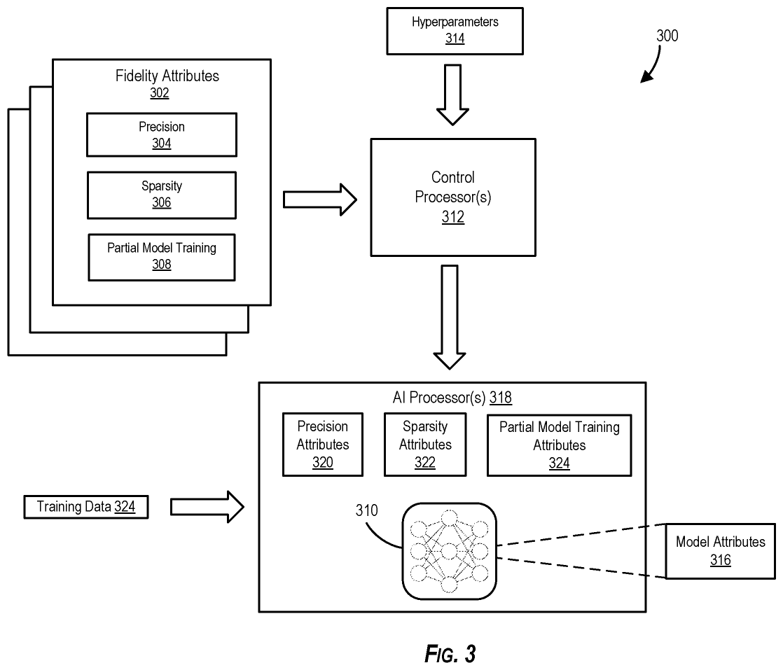

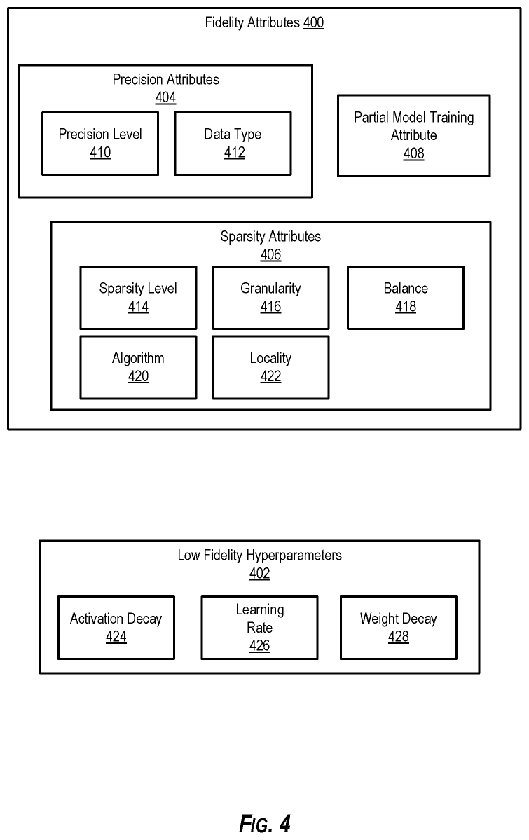

FIG. 3 illustrates an environment 300 in which fidelity attributes 302 are implemented in a neural network training process according to one or more embodiments. The fidelity attributes 302 include one or more attributes of precision attributes 304, sparsity attributes 306, and/or partial model training attributes 308. The fidelity attributes 302 affect the computational resources associated with training a neural network model 310. Such computational resources may be measured in amount of compute power (e.g., cycles), time consumed, or a combination thereof. High fidelity training is typically associated with higher consumption of computational resources whereas low fidelity training is associated with lower consumption of computational resources relative to high fidelity training. Further description of the attributes that may be included in each of the precision attributes 304, the sparsity attributes 306, and the partial model training attributes 308 is provided elsewhere herein (see, e.g., FIG. 4).

One or more control processors 312 receive the fidelity attributes 302, for example, as input provided by one or more users initiating the neural network training process. The input may specify a number of training phases in which the model 310 is to be trained and may specify, for each training phase, a set of criteria for evaluating whether to discontinue the current training phase. The fidelity attributes 302 may be received as part of the training parameters 112 described with respect to FIG. 1. The fidelity attributes 302 include two or more sets of fidelity attributes 302, each set corresponding to a training phase of the neural network training process. The control processor(s) 312 may also receive or determine hyperparameters 314 that will be used to train the model 310 in one or more training phases. The hyperparameters 314 are distinct from the fidelity attributes 302 and may include parameters such as network weight initialization, bias initialization, activation function, momentum, batch size, training algorithm(s), and number of epochs, by way of non-limiting example.

The neural network compiler (see FIG. 1) initially configures the model 310 based on the training parameters received, which may include configuring the model 310 to have model attributes 316 based on the fidelity attributes 302 or the hyperparameters 314. For instance, the control processor 102 may configure the model to have a defined number of layers, defined numbers of nodes for each layers, weights, biases, and so on. The model attributes 316 of the model 310 may also correspond to the sparsity attributes 306, as described herein.

The control processor 312 provides the model 310 having the model attributes 316 to one or more AI processor(s) 318. The control processor 312 also provides instructions to the AI processor(s) 318 regarding how to train the model 310. The AI processor(s) 318 train the model 310 in a plurality of training phases using training data 324 based on the instructions provided by the control processor(s) 312. In particular, training by the AI processor(s) 318 may involve precision attributes 320, sparsity attributes 322, and/or partial model training attributes 324 that correspond to the fidelity attributes 302 based on the instructions provided. The AI processor(s) 318 may provide training information to the control processor 312 regarding a status of the training phase, such as information indicating a correspondence of candidate answers by the model 310 relative to the training data 324. Based on the training information received by the control processor(s) 312, the control processor(s) 312 may determine whether training of the model 310 satisfies one or more criteria for the training phase and instruct the AI processor(s) 318 to discontinue the training phase as a result of a determination that one or more of the criteria are satisfied. In some embodiments, the control processor(s) 312 may provide the set of criteria to the AI processor(s) 318 and the AI processor(s) 318 may independently determine whether to discontinue the training phase.

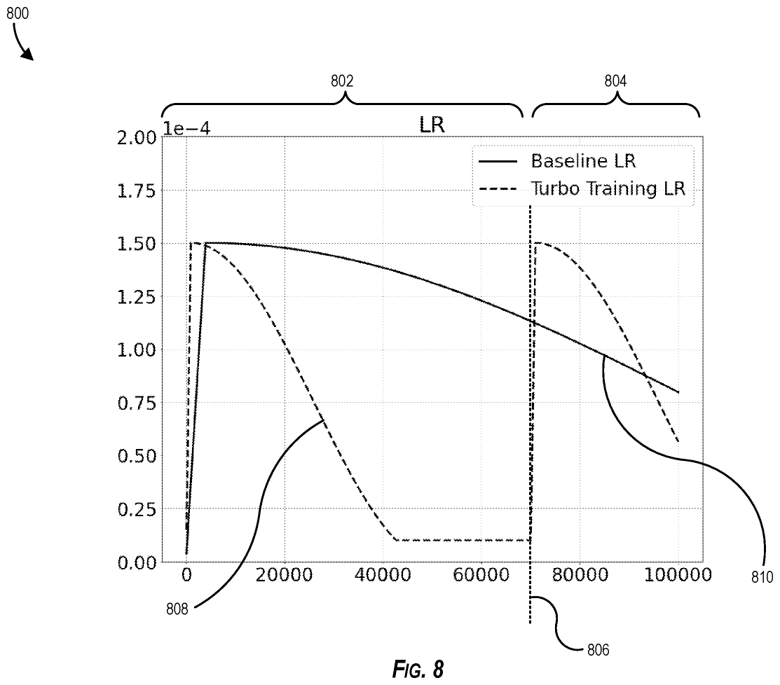

In some instances, one or more hyperparameters related to the precision attributes 320 and/or the sparsity attributes 322 may change or be adjusted throughout a given training cycle based on the instructions provided by the control processor(s) 312. By way of non-limiting example, a learning rate of the model 310 may change (e.g., decrease) over the course of a training phase, which may include continuous change or may include a series of discrete changes to the learning rate. Changes involving other particular attributes are discussed with respect to FIG. 8 and elsewhere herein.

The control processor(s) 312 may, at or as a result of the discontinuance of a training phase, send further instructions to the AI processor(s) 318 regarding a fidelity to be implemented during the next training phase. In particular, the fidelity of an immediately subsequent training phase is higher than the fidelity of the immediately preceding training phase in at least one respect. More specifically, for each successive training phase, at least one of the following conditions is implemented: (i) the model 310 is trained at a higher precision; (ii) the model is trained with a lower sparsity; or (iii) a greater number of contiguous layers is trained. Once a target number of training phases has been implemented or a certain target condition has been achieved (e.g., training loss convergence), the control processor 312 terminates the training process and a trained model is provided.

FIG. 4 illustrates fidelity attributes 400 and low fidelity hyperparameters 402 associated with training phases of a neural network training process according to one or more embodiments. The fidelity attributes 400 include a set of precision attributes 404, a set of sparsity attributes 406, and a set of partial model training attributes 408. Some of the hyperparameters 402 may be set or adjusted based on one or more of the fidelity attributes 400, as described with respect to FIG. 8 and elsewhere herein. The fidelity attributes 400 and/or the hyperparameters 402 may be different for each training phase. For instance, the precision attributes 404 may be lower for a first training phase relative to a second training phase immediately subsequent to the first training phase. Moreover, one or more of the hyperparameters 402 may change or be adjusted throughout a training phase.

The precision attributes 404 include a precision level of operations performed in connection with training the model 310, such as the number of bits utilized (e.g., 32-bit, 64-bit) for operations. The precision attributes 404 may include a data type 412 for the operations performed (e.g., integer, floating point).

The sparsity attributes 306 refer to characteristics of pruning performed on, for example, layers, nodes, weights, connections, or other aspects of the neural network model to be trained. For instance, sparsity attributes 306 may refer to characteristics of one or more kernels applied to aspects of the neural network model. The sparsity attributes 306 may include a sparsity level 414, such as a number of non-zero values relative to a number of zeros in a matrix. The sparsity attributes may 406 also include sparsity granularity 416, which refers to the structure imposed on placement of the non-zero entries of a parameter tensor. Examples of sparsity granularity 416 include fine-grained sparsity (e.g., vanilla sparsity) and coarse-grained sparsity (e.g., channel reduction, filter reduction). The sparsity attributes 406 may include sparsity balance 418, which may refer to a block size or block shape of a kernel applied to aspects of the neural network model. The sparsity attributes 306 may further include a sparsity algorithm 420 utilized to adjust sparsity of the neural network model. The sparsity attributes may include sparsity locality 422, which refers to the parts of the neural network model to which sparsity is applied, such as the layers, nodes, connections, weights, biases, etc.

The low fidelity hyperparameters 402 are hyperparameters that may be tuned in low fidelity training phases. Low fidelity training refers to a fidelity during training in which full precision, no sparsity, and no partial model training is implemented. The hyperparameters 402 are involved in a gradient update for the weights, which is represented by the following Equation [1]:

$${W}_{l}^{t + 1} = {W}_{l}^{t} - η ( \frac{\partial L}{\partial {W}_{l}^{t}} + λ {W}_{l}^{t} ) \qquad [ 1 ]$$

wherein Wᵢ^{t} is the weight matrix in layer l at time t, η is the learning rate, L is the loss,

$$\frac{\partial L}{\partial {W}_{l}^{t}}$$

is the gradient, and λ is the weight decay constant.

The hyperparameters 402 are involved in Equation 1 and include an activation decay 424, a learning rate 426, and a weight decay 428. Activation decay 424 imposes a loss penalty on the output activations of a final layer to the training loss. The activation decay 424 may control or regulate the magnitude of activations for the neural network model. In particular, the activation decay 424 is represented in the following Equation 2 for low fidelity training loss:

L_{LF}=L=λ_{A}∥A_{final}∥₂ [2]

wherein L_{LF} is the training loss for low fidelity training, L is the original loss, ∥Aₗₐₛₜ∥₂ is the L2 norm taken over the output activation of the final layer, and λ_{A} is the activation decay constant. The learning rate 426 of the neural network model controls how quickly the model adapts to achieve the desired behavior. The weight decay 428 controls the magnitude of weights associated with the neural network model—for example, the weight decay 428 may be a coefficient for the L2 norm of the weights. Further description of the hyperparameters 402 is described with respect to FIG. 8.

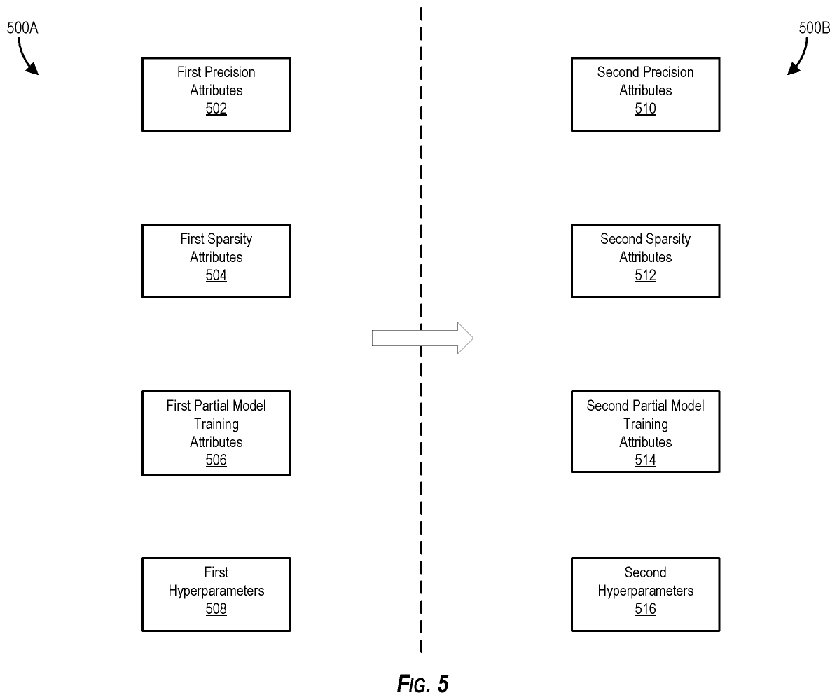

FIG. 5 illustrates an environment in which a neural network model is trained in two training phases according to one or more embodiments. In a first training phase 500A, first precision attributes 502A, first sparsity attributes 504, first partial model training attributes 506, and first hyperparameters 508 are implemented to train a neural network model. In the first training phase 502A, the neural network model is trained at a low fidelity such that the model is trained at a precision less than full precision; the model is trained at greater sparsity than full density; or a subset of contiguous layers of the neural network model are trained. In the first training phase 500A, the first hyperparameters 508 may be tuned to achieve one or more criteria related to the neural network training process in the first phase—for example, the first hyperparameters 508 may be tuned to achieve convergence of the training loss of the neural network model to within a certain threshold (e.g., ±1%). As a result of the neural network training process in the first training phase 500A satisfying one or more training criteria, the neural network training process may proceed to the second training phase 500B.

In the second training phase 500B, the fidelity of the neural network training is increased relative to the fidelity of the training in the first training phase 500A. In particular, one or more attributes of second precision attributes 510, second sparsity attributes 512, and second partial model training attributes 514 correspond to a higher training fidelity than the low fidelity training implemented in the first training phase 500A. The higher training fidelity implemented in the second training phase 500B does not necessarily provide that the second precision attributes 510 correspond to a higher precision than the first precision attributes 502, the second sparsity attributes 512 correspond to a lower sparsity than the first sparsity attributes 504, and that the second partial model training attributes 514 indicate that a greater number of layers are trained in the second training phase 500B than in the first training phase 500A.

As one particular non-limiting example, in the second training phase 500B, the second precision attributes 510 may include precision attributes (e.g., the precision level 410, the data type 412) with a greater precision than the first precision attributes 502, while the second sparsity attributes 512 remain at the same sparsity as the first sparsity attributes 504, and while the second partial model training attributes 514 remain at the same level as the first partial model training attributes 506. As another particular non-limiting example, the second sparsity attributes 512 may include sparsity attributes (e.g., sparsity level 414, sparsity granularity 416, sparsity balance 418, sparsity algorithm 420, sparsity locality 422) with a lower sparsity than the first sparsity attributes 504, while the second precision attributes 510 remain at the same precision as the first sparsity attributes 502, and while the second partial model training attributes 514 remain at the same level as the first partial model training attributes 506. As a further non-limiting example, in the second training phase 500B, the second partial model training attributes 514 may cause a greater number of layers that include the input layer to be trained during the second training phase 500B than the first partial model training attributes 506, while the second precision attributes 510 remain at the same precision as the first sparsity attributes 502, and while the second sparsity attributes 512 remain at the same sparsity as the first sparsity attributes 504.

In some embodiments, two or more of the fidelity attributes in the second training phase 500B may be increased to a higher fidelity than the fidelity attributes implemented during the first training phase 500A. In some embodiments, the second training phase 500B may be a high fidelity training phase in which the second precision attributes 510 correspond to full precision, no sparsity training of all layers of the neural network model. In some embodiments, the second training phase may be an intermediate training phase with a fidelity higher than the first training phase 500A in one or more attributes, but which is less than a highest possible training fidelity for the system.

In some embodiments, one fidelity attribute may decrease and another fidelity attribute may increase for a successive training phase. For instance, in the first training phase 500A, a neural network model may be trained at a first precision level (e.g., 8-bit Integer) and a first sparsity level (e.g., 10% zero weights). Then, in the second training phase 500B, the neural network model may be trained at a second precision level higher than the first precision level (e.g., 24-bit float) and at a second sparsity level higher than the first sparsity level (e.g., 20% zero weights).

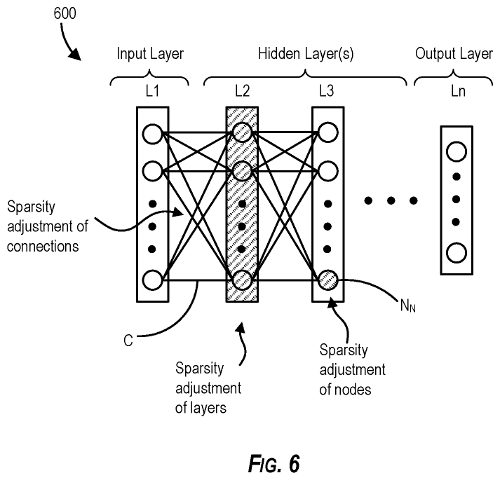

FIG. 6 illustrates an environment in which sparsity of a neural network 600 is adjusted according to one or more embodiments. In this example, control processor(s) (e.g., control processor 102) may adjust sparsity associated with one or more target layers, target nodes, and/or target connections of a model. Control processor(s) may adjust sparsity to increase training fidelity. For example, the model may initially be configured with lower sparsity resulting in fewer calculations skipped and values forced to zero. Based on one or more statistics, such as a low gradient noise in the second layer (L2), the control processor(s) may adjust sparsity associated with the second layer (L2) to provide higher sparsity resulting in more calculations skipped and values forced to zero while one or more other layers may remain with the initially configured lower sparsity. This adjustment of the second layer (L2) may adjust fidelity for training the second layer (L2) during a training phase. For instance, in a first training phase, the second layer (L2) may be removed or excluded from training to implement a lower fidelity. Then, in a subsequent training phase, the second layer (L2) may be added or included in training to increase fidelity.

Continuing with the foregoing example, additionally, or alternatively, the control processor(s) may adjust sparsity associated with a given node of a target layer, such as a last node NN of the third layer (L3). This adjustment in the third layer (L3) may adjust the fidelity associated with the third layer (L3). For example, in a first training phase, the node NN may be removed or excluded from training to implement a lower fidelity. Then, in a subsequent training phase, the node NN may be added or included in training to increase fidelity.

As a further example, the control processor(s) may adjust the sparsity associated with a given connection between two nodes of adjacent layers of the neural network 600, such as a connection C between the last node of the first layer (L1) and the last node of the second layer (L2). The connection C may be removed or excluded from training in a first training phase to implement a lower fidelity. Then, in a subsequent training phase, the connection C may be added or included in training to increase fidelity.

It should be appreciated that many different configurations are possible for adjusting sparsity differently in various portions of a model. For instance, sparsity may be implemented via shapes, sizes, balances, etc., of kernels used to implement sparsity in a neural network. Moreover, sparsity may be implemented in other aspects of the neural network 600 not described with respect to FIG. 6, such as weights, activations, gradients, and so forth.

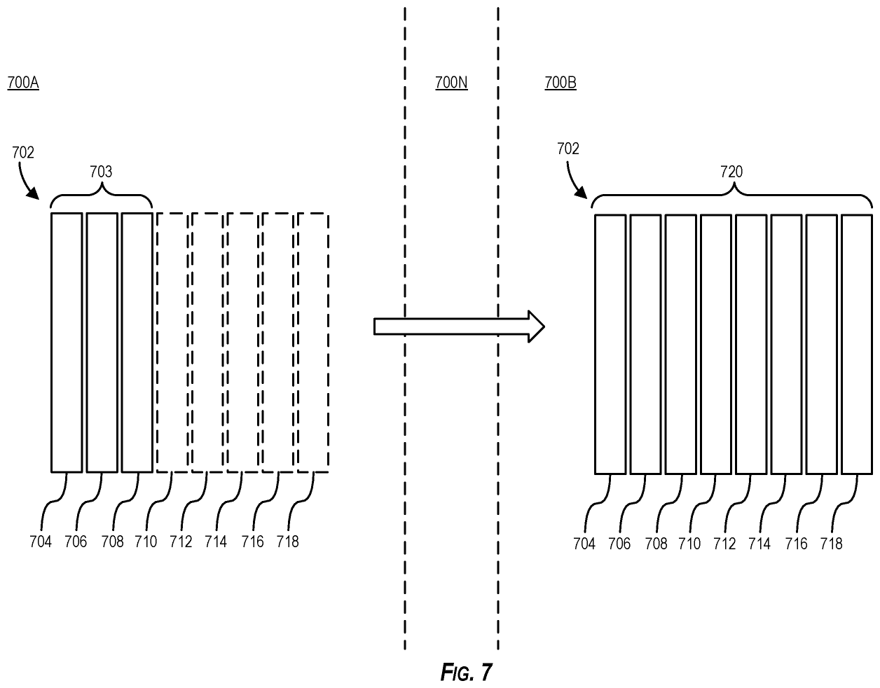

FIG. 7 illustrates a training environment in which a neural network model 702 is trained during a first training phase 700A and a second training phase 700B according to one or more embodiments. In the first training phase 700A, a partial model training process is implemented in which a subset of layers 703 of the model 702 are trained, the subset 703 being fewer in number than a total number of layers of the model 702 (i.e., a proper subset). For instance, in the first training phase 700A, an input layer 704, a hidden layer 706, and a hidden layer 708 are trained whereas hidden layers 710 through 716 and an output layer 718 are not trained during the first training phase 700A. Partial model training according to the present disclosure includes training a contiguous proper subset of layers of a neural network model. In some embodiments, the contiguous subset of layers trained in partial model training includes training an input layer of a neural network.

In the second training phase 700B, which is the final training phase for training a neural network 702 shown, all layers 720 of the neural network model 702 are trained and a trained neural network model is produced thereby. In some embodiments, a set of intermediate training phases 700N may be implemented to train the neural network model 702, the set of intermediate training phases 700N being implemented between the first training phase 700A and the second training phase 700B. In one or more embodiments, the set of intermediate training phases 700N are partial model training phases in which a subset of the layers 720 are trained. In one or more embodiments, the set of intermediate training phases 700N are full model training phases in which all layers 720 are trained. In some embodiments, one subset of the intermediate training phases 700N are partial model training phases and a remaining subset of the intermediate training phases 700N are full model training phases.

FIG. 8 illustrates a graph 800 of a first learning rate associated with training a first neural network model relative to a second learning rate associated with training a second neural network model according to one or more embodiments. More specifically, a training process for training the first neural network includes a first training phase 802 and a second training phase 804, the first training phase 802 implemented prior to a time 806 and the second training phase 804 implemented subsequent to the time 806. A first learning rate 808 for training a neural network model involves a warm-up period in which the learning rate of the model increases quickly and then gradually decays to a baseline level. Then, at the time 806 when it is determined that training of the neural network model during the first training phase 802 satisfies one or more training criteria (e.g., training loss convergence is achieved), the learning rate 808 quickly increases again to a peak and begins to descend back to the baseline. This process may repeat until the neural network model is fully trained. As described herein, the second training phase 804 involves training a neural network at a higher fidelity than a fidelity utilized to train the neural network during the first training phase 802.

Although the learning rate 808 in the multi-phase training procedure described includes similar features, such as peak learning rate and decay rate, the learning rate profiles of the learning rate 808 in the first training phase 802 may be different than the learning rate profile of the learning rate 808 in the second training phase 804 in some embodiments. It is understood that the training process may include more than two training phases without departing from the scope of the present disclosure.

By way of comparison, a second learning rate 810 is associated with training a neural network model in a single training phase. As shown in FIG. 8, the second learning rate 810 has a longer warm-up period and a longer learning rate decay than the learning rate 808 of the first neural network model during the first training phase 802.

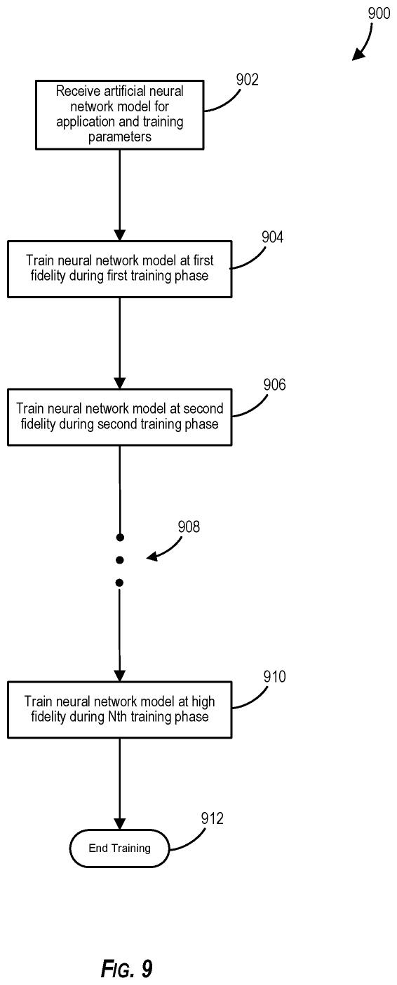

FIG. 9 shows a method 900 for training a neural network model at a different fidelities over a plurality of training phases according to one or more embodiments. The method 900 may be performed by one or more processing entities described herein, such as the control processor(s) 102 and/or the AI processor(s) 104. At 902, one or more processors receive a neural network model (e.g., the model 110) and may receive parameters for training the neural network model, as described elsewhere herein. At 904, the neural network model is trained 904 at a first fidelity during a first training phase. The first fidelity is a low fidelity level in which a lower precision, a higher sparsity, and/or a partial training model are implemented to train the neural network model. As a result of determining that one or more training criteria associated with the first training phase are satisfied in 904, the method 900 proceeds to 906.

At 906, the neural network model is trained at a second fidelity higher than the first fidelity during a second training phase. The second fidelity is higher with respect to one or more fidelity attributes (e.g., fidelity attributes 400) than the first fidelity implemented in 904. For instance, at 906, at least one attribute described with respect to the precision attributes 404 in FIG. 4 have a higher precision than a precision implemented in 904. As another example, at 906, at least one attribute described with respect to the sparsity attributes 406 in FIG. 4 have a lower sparsity than a sparsity implemented in 904. As a further example, a number of contiguous layers of the neural network model trained in 906 is greater than a number of contiguous layers of the neural network model trained in 904. As a result of determining that one or more training criteria associated with the second training phase are satisfied in 906, the method 900 proceeds to implement additional training phases.

At 908, one or more additional training phases may be implemented, wherein each successive training phase has a higher fidelity for one or more fidelity attributes than an immediately preceding training phase. At each training phase, various hyperparameters may change or be updated to improve the training process (e.g., by reducing the time or computing resources implemented in training the neural network model in a particular training phase). At each successive training phase in 908, one or more criteria related to training of the neural network model are satisfied before the fidelity is increased in the next training phase and the hyperparameters are tuned for the current training phase.

At 910, the neural network model is trained at high fidelity (i.e., full precision, no sparsity, full model training) until one or more desired target criteria for training are satisfied. For instance, a neural network model may be trained until the control processor(s) determine that training of the neural network model has converged to within a desired threshold, such as a defined training loss threshold. As a result of a determination that training of the neural network model satisfies one or more final training criteria, training of the neural network may cease at 912 and the fully trained neural network model may be provided.

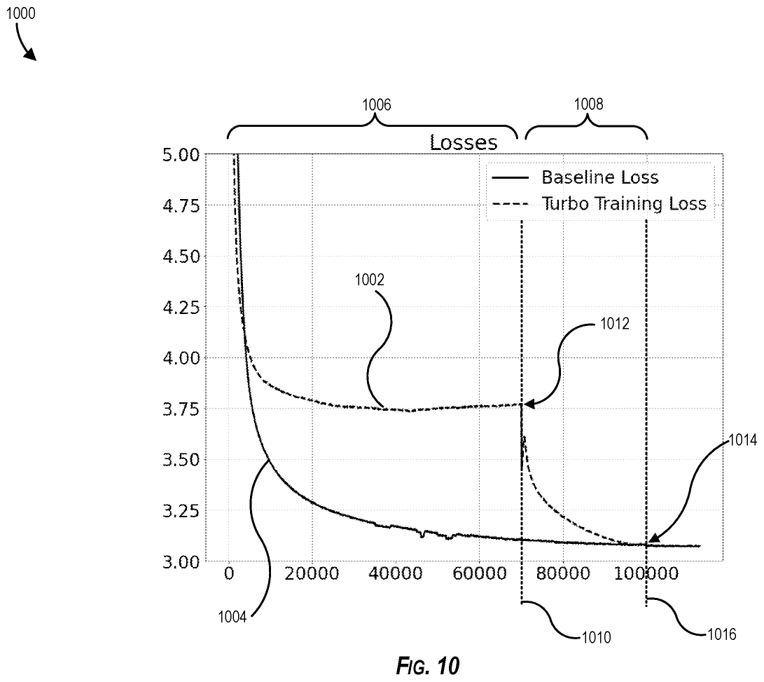

FIG. 10 illustrates a graph 1000 of a first training loss 1002 relative to a second training loss 1004 according to one or more embodiments herein. In particular, the first training loss 1002 corresponds to training loss associated with training a first neural network model at a first fidelity for a first training phase 1006 and training the first neural network at a second fidelity higher than the first fidelity for a second training phase 1008. By contrast, the second training loss 1004 corresponds to training loss associated with training a second neural network model entirely at high fidelity (i.e., full precision, no sparsity, full model training). During the first training period 1006, the first neural network model is trained at a low fidelity, as described herein. Therefore, the computational resources dedicated to training the first neural network model during the first training period 1006 are less than the computational resources dedicated to training the second neural network model at high fidelity.

During the first training period 1006, the first training loss 1002 initially decreases at a rate similar to the second training loss 1004, but then begins to stagnate. At a time 1010, it is determined (e.g., by the control processor(s), by the AI processor(s)) that training of the first neural network during the first training phase satisfies one or more criteria—in this case, that the first training loss 1002 during the first training period 1006 has converged, as described with respect to 208 of FIG. 2 and elsewhere herein. For instance, the first training loss 1002 remains within a defined threshold (e.g., ±1%) of a first loss value 1012 for a defined length of time or for a defined number of samples. As a result, at or around the time 1010, the AI processor(s) train the first neural network model during the second training period 1008 at a higher fidelity than training during the first training period 1006. In some embodiments, the higher fidelity used to train the second neural network model in the second training phase 1008 may be high fidelity training at full precision, no sparsity, and full model training.

As a result of the increased fidelity in the second training phase 1008, the rate of the first training loss 1002 sharply decreases and begins to trend toward a second loss value 1014 to which the second training loss 1004 converges. At a time 1016, it is determined that the first training loss 1002 of the first neural network model has converged to the second loss value 1014 and the neural network training process of the second neural network model ends, as described with respect to 216 of FIG. 2 and elsewhere herein.

Advantageously, the computational cost of training the first neural network model in the first training phase 1006 is significantly reduced relative to the computational cost of training the second neural network model. The performance of the fully trained first neural network model in terms of training loss is similar to or the same as the performance of the fully trained second neural network model despite the difference in computational cost (e.g., computational resources used). This computational cost savings is significant as a time period of the first training phase 1006 may be longer than the second training phase 1008. For example, in the graph 1000, the first training phase 1006 accounts for ˜70% of the total training time whereas the second training phase 1008 accounts for the remaining ˜30% of the total training time. Moreover, the neural network training process described herein (i.e., as represented by the first training loss 1002) achieves a comparable performance at least in training loss relative to a neural network model trained at high fidelity (i.e., as represented by the second training loss 1004) in the same amount of time or less, but at a lower computational cost.

### Example Computer System

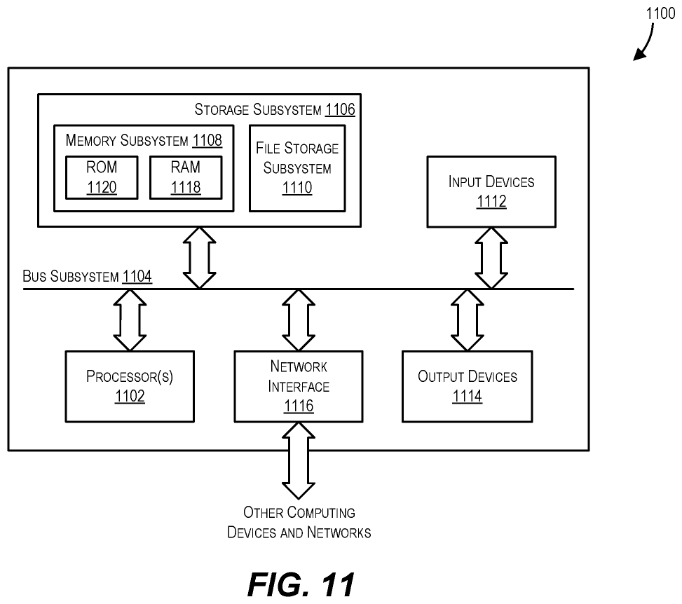

FIG. 11 depicts a simplified block diagram of an example computer system 1100 according to certain embodiments. Computer system 1100 can be used to implement any of the computing devices, systems, or servers described in the foregoing disclosure. As shown in FIG. 11, computer system 1100 includes one or more processors 1102 that communicate with a number of peripheral devices via a bus subsystem 1104. These peripheral devices include a storage subsystem 1106 (comprising a memory subsystem 1108 and a file storage subsystem 1110), user interface input devices 1112, user interface output devices 1114, and a network interface subsystem 1116.

Bus subsystem 1104 can provide a mechanism for letting the various components and subsystems of computer system 1100 communicate with each other as intended. Although bus subsystem 1104 is shown schematically as a single bus, alternative embodiments of the bus subsystem can utilize multiple busses.

Network interface subsystem 1116 can serve as an interface for communicating data between computer system 1100 and other computer systems or networks. Embodiments of network interface subsystem 1116 can include, e.g., an Ethernet card, a Wi-Fi and/or cellular adapter, a modem (telephone, satellite, cable, ISDN, etc.), digital subscriber line (DSL) units, and/or the like.

User interface input devices 1112 can include a keyboard, pointing devices (e.g., mouse, trackball, touchpad, etc.), a touch-screen incorporated into a display, audio input devices (e.g., voice recognition systems, microphones, etc.) and other types of input devices. In general, use of the term “input device” is intended to include all possible types of devices and mechanisms for inputting information into computer system 1100.

User interface output devices 1114 can include a display subsystem, a printer, or non-visual displays such as audio output devices, etc. The display subsystem can be, e.g., a flat-panel device such as a liquid crystal display (LCD) or organic light-emitting diode (OLED) display. In general, use of the term “output device” is intended to include all possible types of devices and mechanisms for outputting information from computer system 1100.

Storage subsystem 1106 includes a memory subsystem 1108 and a file/disk storage subsystem 1110. Subsystems 1108 and 1110 represent non-transitory computer-readable storage media that can store program code and/or data that provide the functionality of embodiments of the present disclosure.

Memory subsystem 1108 includes a number of memories including a main random access memory (RAM) 1118 for storage of instructions and data during program execution and a read-only memory (ROM) 1120 in which fixed instructions are stored. File storage subsystem 1110 can provide persistent (i.e., non-volatile) storage for program and data files, and can include a magnetic or solid-state hard disk drive, an optical drive along with associated removable media (e.g., CD-ROM, DVD, Blu-Ray, etc.), a removable flash memory-based drive or card, and/or other types of storage media known in the art.

It should be appreciated that computer system 1100 is illustrative and many other configurations having more or fewer components than system 1100 are possible.

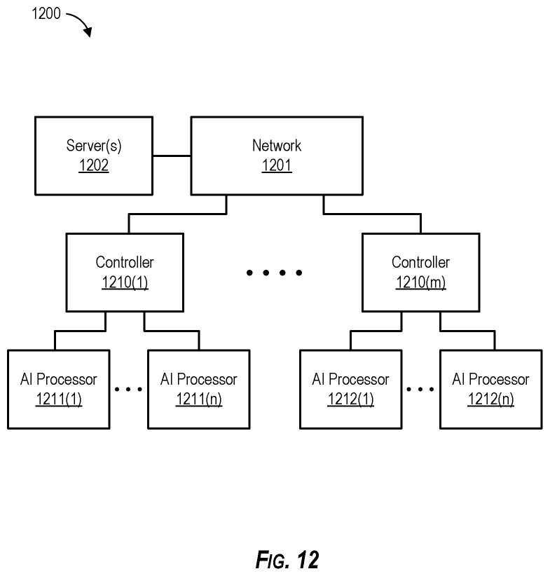

FIG. 12 illustrates an artificial neural network processing system according to some embodiments. In various embodiments, neural networks (e.g., neural network model 310) according to the present disclosure may be implemented and trained in a hardware environment comprising one or more neural network processors (e.g., AI processor(s)). A neural network processor may refer to various graphics processing units (GPU) (e.g., a GPU for processing neural networks produced by Nvidia Corp®), field programmable gate arrays (FPGA) (e.g., FPGAs for processing neural networks produced by Xilinx®), or a variety of application specific integrated circuits (ASICs) or neural network processors comprising hardware architectures optimized for neural network computations, for example. In this example environment, one or more servers 1202, which may comprise architectures illustrated in FIG. 11 above, may be coupled to a plurality of controllers 1210(1)-1210(M) over a communication network 1201 (e.g., switches, routers, etc.). Controllers 1210(1)-1210(M) may also comprise architectures illustrated in FIG. 11 above. Each controller 1210(1)-1210(M) may be coupled to one or more neural network (NN) processors, such as processing units 1211(1)-1211(N) and 1212(1)-1212(N), for example.

NN processing units 1211(1)-1211(N) and 1212(1)-1212(N) may include a variety of configurations of functional processing blocks and memory optimized for neural network processing, such as training or inference. The NN processors are optimized for neural network computations. Server 1202 may configure controllers 1210 with NN models as well as input data to the models, which may be loaded and executed by NN processing units 1211(1)-1211(N) and 1212(1)-1212(N) in parallel, for example. Models may include layers and associated weights as described above, for example. NN processing units may load the models and apply the inputs to produce output results. NN processing units may also implement training algorithms described herein, for example.

The above description illustrates various embodiments of the present disclosure along with examples of how aspects of these embodiments may be implemented. The above examples and embodiments should not be deemed to be the only embodiments, and are presented to illustrate the flexibility and advantages of the present disclosure as defined by the following claims. For example, although certain embodiments have been described with respect to particular process flows and steps, it should be apparent to those skilled in the art that the scope of the present disclosure is not strictly limited to the described flows and steps. Steps described as sequential may be executed in parallel, order of steps may be varied, and steps may be modified, combined, added, or omitted. As another example, although certain embodiments have been described using a particular combination of hardware and software, it should be recognized that other combinations of hardware and software are possible, and that specific operations described as being implemented in software can also be implemented in hardware and vice versa.

The specification and drawings are, accordingly, to be regarded in an illustrative rather than restrictive sense. Other arrangements, embodiments, implementations and equivalents will be evident to those skilled in the art and may be employed without departing from the spirit and scope of the present disclosure as set forth in the following claims.

What is claimed is:

1. A computer system comprising:
one or more control processors; and
a non-transitory computer readable medium having stored thereon program code executable by the one or more control processors, the program code causing the one or more control processors to:
train a neural network model according to a first fidelity level on one or more AI processors during a first training phase using training data;
determine that training of the neural network model during the first training phase satisfies one or more criteria; and
train, as a result of the training of the neural network model during the first training phase satisfying the one or more criteria, the neural network model according to a second fidelity level on the one or more AI processors during a second training phase using the training data, the second fidelity level being a higher level of fidelity than the first fidelity level, the training of the neural network model during the first training period and the second training period reducing a computational cost.

2. The computer system of claim 1, wherein the program code further causes the one or more control processors to:
operate the one or more AI processors at a first precision computation level during the first training phase; and
operate the one or more AI processors at a second precision computation level during the second training phase, the second precision computation level being a higher precision computation level than the first precision computation level.

3. The computer system of claim 1, wherein the program code causes the one or more control processors to:
train the neural network model at a first sparsity during the first training phase; and
train the neural network model at a second sparsity during the second training phase, the second sparsity being a lower sparsity than the first sparsity.

4. The computer system of claim 1, wherein the determination that the one or more criteria are satisfied includes a determination that the neural network model is within a defined threshold for convergence.

5. The computer system of claim 1, wherein a first subset of neural network layers of the neural network model is trained during the first training phase, and a second subset of the neural network layers is trained during the second training phase, the first subset being a smaller subset than the second subset.

6. The computer system of claim 5, wherein the first subset is a contiguous subset of neural network layers of the neural network model.

7. The computer system of claim 1, wherein the program code further causes the one or more control processors to:
train the neural network model according to a third fidelity level on the one or more AI processors during a third training phase using the training data, the third fidelity level being a higher level of fidelity than the second fidelity level.

8. The computer system of claim 1, execution of the program code causing the one or more control processors to:
adjust one or more training hyperparameters to a first set of settings for training during the first training phase; and
adjust the one or more training hyperparameters to a second set of settings for training during the second training phase.

9. The computer system of claim 8, wherein the one or more training hyperparameters include at least one hyperparameter of learning rate, dropout, network weight initialization, activation function, momentum, or batch size.

10. A method comprising:
training, during a first training phase, a neural network model executing on one or more Artificial Intelligence (AI) processors according to a first fidelity level using training data;
determining that training of the neural network model during the first training phase satisfies a first set of criteria; and
training, as a result of determining that training of the neural network model satisfies the first set of criteria, the neural network model according to a second fidelity level during a second training phase using the training data, the second fidelity level having one or more fidelity attributes with a higher level than the first fidelity level.

11. The method of claim 10, wherein training the neural network model according to the to the first fidelity level includes operating the one or more AI processors at a first precision computation level, and training the neural network model according to the second fidelity level includes operating the one or more AI processors at a second precision computation level that is a higher precision computation level than the first precision computation level.

12. The method of claim 10, comprising:
implementing, during the first training phase, a first set of sparsity settings for training the neural network model; and
implementing, during the second training phase, a second set of sparsity settings for training the neural network model, the second set of sparsity settings including one or more settings for a higher density level than the first set of sparsity settings.

13. The method of claim 10, wherein determining that the one or more criteria are satisfied includes determining that the neural network model is within a defined threshold for convergence.

14. The method of claim 10, comprising:
determining that training of the neural network model during the second training phase satisfies a second set of criteria; and
training, as a result of determining that training of the neural network model satisfies the second set of criteria, the neural network model according to a third fidelity level during a third training phase using the training data, the third fidelity level having one or more fidelity attributes with a higher level than the second fidelity level.

15. The method of claim 10, comprising:
determining, based at least in part on the second training phase, that a quality of the neural network model is within a defined threshold of a baseline neural network.

16. A non-transitory computer readable medium having stored thereon program code executable by a computer system, execution of the program code causing the computer system to:
train a neural network model according to a first fidelity level on the one or more AI processors during a first training phase using training data;
determine that training of the neural network model during the first training phase satisfies one or more criteria; and
train, as a result of the training satisfying the one or more criteria, the neural network model according to a second fidelity level on the one or more AI processors during a second training phase using the training data, the second fidelity level being a higher level of fidelity than the first fidelity level.

17. The non-transitory computer readable medium of claim 16, wherein execution of the program code causes the computer system to:
operate, during the first training phase, the one or more AI processors at a first precision computation level according to the first fidelity level; and
operate, during the second training phase, the one or more AI processors at a second precision computation level according to the second fidelity level, the second precision computation level being a higher level of precision computation than the first precision computation level.

18. The non-transitory computer readable medium of claim 16, wherein execution of the program code causes the computer system to:
train, during the first training phase, the neural network model at a first sparsity according to the first fidelity level; and
train, during the second training phase, the neural network model at a second sparsity according to the second fidelity level, the second sparsity being a lower level of sparsity than the first sparsity.

19. The non-transitory computer readable medium of claim 16, wherein the one or more criteria specify a defined threshold of convergence for the neural network model.

20. The non-transitory computer readable medium of claim 16, wherein execution of the program code further causes the computer system to:
receive a set of training parameters for training the neural network model; and
train, during the first training phase, a contiguous subset of neural network layers of the neural network model based on the training parameters, the contiguous subset being fewer in numbers than a total number of layers of the neural network model.
